(19) United States
(12) Patent Application Publication
(10) Pub. No.: US 2003/0053064 A1
(43) Pub. Date: Mar. 20, 2003

(54) Wavelength detector and optical transmitter

(76) Inventors: Yasunori Nishimura, Tokyo (JP); Shinichi Takagi, Tokyo (JP); Masao Imaki, Tokyo (JP); Yoshihito Hirano, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/097,272

(22) Filed: Mar. 15, 2002

(30) Foreign Application Priority Data
Aug. 29, 2001 (JP) 2001-259036

(51) Int. Cl. G01N 21/25

(52) U.S. Cl. 356/414

(57) ABSTRACT

There are disclosed a wavelength detector capable of accurately detecting the wavelength of an entered light beam by a simple configuration without needing any highly accurate fine-adjustments, and an optical transmitter equipped with the wavelength detector. The wavelength detector comprises: a polarizing beam splitter configured to split the light beam emitted from a light source to first and second polarized light components orthogonal to each other; first and second photo-detectors configured to receive the first and second polarized light components, and output corresponding first and second electric signals respectively; first and second wavelength filters respectively disposed in first and second optical paths between the polarizing beam splitter and the first photo-detector and between the polarizing beam splitter and the second photo-detector; and a wavelength detecting circuit for generating, based on the first and second electric signals, an output signal corresponding to the wavelength of the light beam.

### BACKGROUND OF THE INVENTION

1. Field of the invention

The present invention relates to a wavelength detector and an optical transmitter. More particularly, the invention relates to, for example a wavelength detector suitably used for an optical transmitter employing a wavelength division multiplexing transmission system, and the optical transmitter.

2. Description of the Related Art

With regard to an optical transmitter, in recent years, a variety of transmission systems have been presented to meet the request of a larger capacity for information to be transmitted. One among those systems is a wavelength division multiplexing transmission system configured to increase a transmission capacity by multiplexing a number of optical signals having different optical wavelengths, and propagating the signals through one optical fiber.

However, even when a plurality of optical signals having different wavelengths are multiplexed and simultaneously transmitted, only wavelengths of a band to be amplified by an amplifier can be used. Consequently, to multiplex many optical signals, not only the wavelength width of each optical signal but also a wavelength interval between optical signals must be narrowed. In order to solve this problem, a technology is required to detect the wavelength of an optical signal of a narrow band, and stabilize this wavelength with high accuracy.

FIG. 8 shows the configuration of a conventional device disclosed in Japanese Patent Application Laid-open No. 2-228625. As shown in FIG. 8, a light beam emitted from a semiconductor laser 21 is converted into parallel beams through an optical lens 22, and then split to two systems by a beam splitter 23. One of these light beams is converged through an optical lens 24 on a first photo-detector 25, and the detection output thereof enables a power of the laser light to be monitored. The other light beam is made incident on Fabry-Pérot resonator composed of reflecting mirrors 26 and 27 oppositely disposed in parallel, away from each other by a length L in the direction of an optical axis. This resonator resonates with an optionally set frequency of a light beam to stabilize the oscillation wavelength of the semiconductor laser. The light beam transmitted through the resonator is converged through an optical lens 28 on a second photo-detector 29, and the detection output thereof enables a wavelength of the light beam to be monitored.

The Fabry-Pérot resonator outputs its transmitted beam with a free spectral spacing decided by C/(2 nL) set as a cycle. Here, C denotes a velocity of light; n a refractive index in the Fabry-Pérot resonator; and L a distance between the reflecting mirrors.

However, the following problems have been inherent in a waveform stabilizer using the foregoing conventional Fabry-Pérot resonator.

That is, to optionally set a frequency, a distance L between the two reflecting mirrors of the Fabry-Pérot resonator must be fine-adjusted with submicron accuracy. In addition, miniaturization is difficult because of the presence of a movable portion for spacing adjustment.

The present invention has been developed to solve the above-described problems, and it is an object of the invention to provide a wavelength detector capable of accurately detecting the wavelength of a light beam by a simple configuration without needing any highly accurate fine-adjustments.

It is another object of the invention to provide an optical transmitter equipped with the wavelength detector.

A wavelength detector regarding the present invention comprises a polarizing beam splitter configured to split a light beam emitted from a light source to first and second beams, the first and second beams having first and second polarized light components, respectively, that have an orthogonal relationship to each other; first and second photo-detectors configured to receive the first and second light beams and output first and second electric signals, respectively; first and second wavelength filters disposed in first and second optical paths between the polarizing beam splitter and the first photo-detector and between the polarizing beam splitter and the second photo-detector, respectively.

The wavelength detector regarding the present invention may comprise a polarizing beam splitter configured to split a light beam emitted from a light source to first and second beams, the first and second beams having first and second polarized light components, respectively, that have an orthogonal relationship to each other; first and second photo-detectors configured to receive the first and second light beams and output first and second electric signals, respectively; first and second wavelength filters disposed in first and second optical paths between the polarizing beam splitter and the first photo-detector and between the polarizing beam splitter and the second photo-detector, respectively; a detecting circuit for generating, based on the first and second electric signals, an output signal corresponding to the wavelength of the light beam.

Furthermore, the wavelength detector of the present invention may further comprise a beam splitter disposed in an optical path from the light source to the polarizing beam splitter to generate another light beam, and a third photo-detector configured to receive the other light beam and generate a third electric signal corresponding to a power of the other beam; the detecting circuit generating the output signal by adding the first and second electric signals to each other and then dividing the added first and second electric signals by the third electric signal.

Furthermore, the first and second wavelength filters may be constructed by combination of a birefringence crystal and a polarizer, respectively.

Furthermore, a fast axis of the first birefringence crystal may be set 45 degree tilted to the polarization of the light beam.

Furthermore, the first and second wavelength filters may be constructed by combination of first birefringence crystal, second birefringence crystal and a polarizer, respectively.

Furthermore, a fast axis of the first birefringence crystal may be set 45 degree tilted to the polarization of the light beam.

Furthermore, the second birefringence crystal may be set to compensate phase deviation between fast axis and slow axis of the first birefringence crystal occurring by thermal change.

Furthermore, YVO₄ crystal may be used as the first birefringence crystal, and LiNbO₃ crystal may be used as the second birefringence crystal.

Furthermore, the wavelength detector regarding the present invention may comprise a polarizing beam splitter configured to split a light beam emitted from a light source to first and second beams, the first and second beams having first and second polarized light components, respectively, that have an orthogonal relationship to each other; first and second photo-detector configured to receive the first and second light beams and output first and second electric signals, respectively; a wavelength filter disposed in first and second optical paths between the polarizing beam splitter and the first and second photo-detector; a half-wave plate disposed in the second optical path between the polarizing beam splitter and the wavelength filter to rotate the polarization of the second light beam; and a mirror disposed in the second optical path between the polarized beam splitter and the half-wave plate.

Furthermore, the wavelength detector regarding the present invention may comprise a polarizing beam splitter configured to split a light beam emitted from a light source to first and second beams, the first and second beams having first and second polarized light components, respectively, that have an orthogonal relationship to each other; first and second photo-detectors configured to receive the first and second light beams and output first and second electric signals, respectively; a wavelength filter disposed in first and second optical paths between the polarizing beam splitter and the first and second photo-detector; a half-wave plate disposed in the second optical path between the polarizing beam splitter and the wavelength filter to relate the polarization of the second light beam; a mirror disposed in the second optical path between the polarized beam splitter and the half-wave plate; and a detecting circuit for generating, based on the first and second electric signals, an output signal corresponding to the wavelength of the light beam.

Furthermore, the first and second photo-detectors may be disposed on one substrate.

Furthermore, the wavelength detector may further comprise a beam splitter disposed in an optical path from the light source to the polarizing beam splitter to generate another light beam; and third photo-detector configured to receive the other light beam and generate a third electric signal corresponding to a power of the other light beam; the detecting circuit generating the output signal by adding the first and second electric signals to each other and then dividing the added first and second electric signals by the third electric signal.

Furthermore, the wavelength filter may be constructed by combination of a birefringence crystal and a polarizer.

Furthermore, a fast axis of the first birefringence crystal may be set 45 degree tilted to the polarization of the light beam.

Furthermore, the wavelength filter may be constructed by combination of first birefringence crystal, second birefringence crystal and a polarizer.

Furthermore, a fast axis of the first birefringence crystal may be set 45 degree tilted to the polarization of the light beam.

Furthermore, the second birefringence crystal may be set to compensate phase deviation between fast axis and slow axis of the first birefringence crystal occurring by thermal change.

Furthermore, YVO₄ crystal may be used as the first birefringence crystal, and LiNbO₃ crystal may be used as the second birefringence crystal.

Furthermore, an optical transmitter for transmitting light regarding the present invention comprises a light source emitting light beam; an optical fiber cable for transmitting light beam; a coupler disposed in between the optical fiber cable configured to split the light beam; a wavelength detector for detecting a wavelength of a light beam; and control circuit for controlling the light source; the wavelength detector comprising: a polarizing beam splitter configured to split the light beam to first and second beams; the first and second beams having first and second polarized light components, respectively, that have an orthogonal relationship to each other; first and second photo-detectors configured to receive the first and second light beams and output first and second electric signals, respectively; first and second wavelength filters disposed in first and second optical paths between the polarizing beam splitter and the first photo-detector and between the polarizing beam splitter and the second photo-detector, respectively; a detecting circuit for generating, based on the first and second electric signals, an output signal corresponding to the wavelength of the light beam.

### BRIEF DESCRIPTION OF THE DRAWINGS

FIG. 1 is a block diagram showing a wavelength detector according to a first embodiment of the present invention.

FIG. 2 is a view illustrating an arrangement of a birefringence crystal according to the first embodiment.

FIG. 3 is a graph showing an intensity of an electric signal with respect to a wavelength according to the first embodiment.

FIG. 4 is a block diagram showing a wavelength detector according to a second embodiment of the invention.

FIG. 5 is a block diagram showing a wavelength detector according to a third embodiment of the invention.

FIG. 6 is a block diagram showing a wavelength detector according to a fourth embodiment of the invention.

FIG. 7 is a block diagram showing an optical transmitter according to a fifth embodiment of the invention.

FIG. 8 is a block diagram showing a conventional wavelength detector.

### DESCRIPTION OF THE PREFERRED EMBODIMENTS

First Embodiment

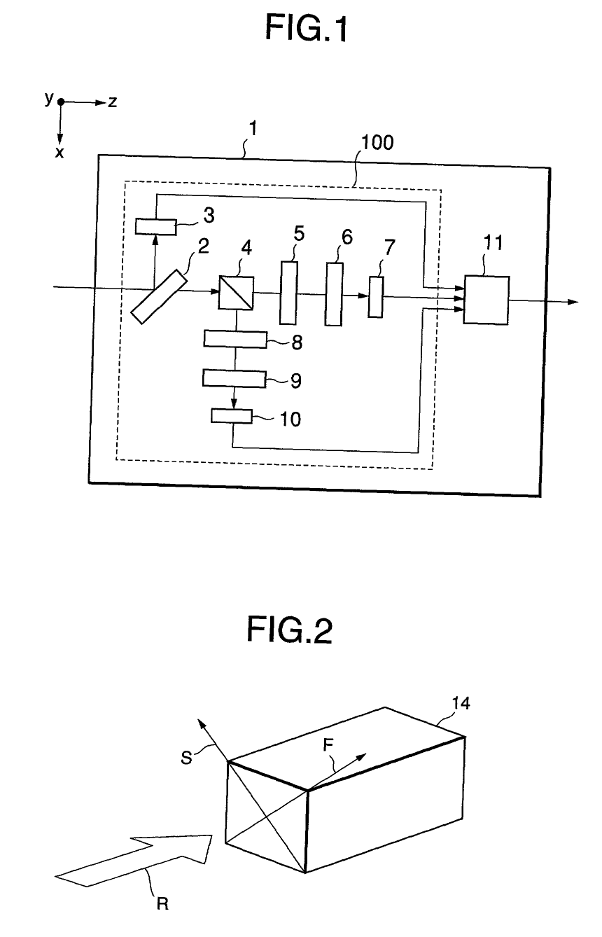

Each of FIGS. 1 to 3 illustrates a wavelength detector according to the first embodiment of the present invention. In FIG. 1, a wavelength detector main body 1 comprises an optical system 100 and a wavelength detecting circuit 11. The optical system 100 includes a beam splitter 2, a photo-detector 3, a polarizing beam splitter 4, a birefringence crystal 5, a polarizer 6, a photo-detector 7, a birefringence crystal 8, a polarizer 9, and a photo-detector 10.

The beam splitter 2 splits an incident light beam in two directions. The photo-detector 3 receives a power of a first light beam split by the beam splitter. The polarizing beam splitter 4 receives a power of a second light beam split by the beam splitter, and splits the light beam to first and second polarized light components vibrated in directions orthogonal to each other. The birefringence crystal 5 receives the first polarized light component, and changes the polarized state of the first polarized light component according to the wavelength of the light beam. The polarizer 6 receives the light beam from the birefringence crystal 5, and transmits only the polarized light of a specified direction. The photo-detector 7 receives the first polarized light component transmitted through the polarizer 6. The birefringence crystal 8 receives the second polarized light component, and changes the polarized state of the second polarized light component according to the wavelength of the light beam. The polarizer 9 receives the light beam from the birefringence crystal 8, and transmits a polarized light in a direction orthogonal to the transmitting direction of the polarizer 9. The photo-detector 10 receives the second polarized light component transmitted through the polarizer 9. The wavelength detecting circuit 11 receives the outputs of the photo-detectors 3, 7 and 10.

The birefringence crystals 5 and 8 have optical anisotropies, a fast axis F and a slow axis S, respectively, orthogonal to each other within a surface vertical to the advancing direction of an incident light beam as shown in FIG. 2. In the direction of the fast axis F, a phase velocity is high, and a refractive index is low. In the direction of the slow axis S, a phase velocity is low, and a refractive index is high. According to the invention, the birefringence crystals 5 and 8 are disposed such that the incident light beam is transmitted through the polarizing beam splitter to become a linear polarized beam, and the directions of the fast and slow axes F and S are tilted by 45° to the vibration directions of the first and second polarized light components orthogonal to each other.

In addition, the polarizers 6 and 9 are disposed such that the polarizing directions of transmitted beams thereof are orthogonal to each other.

Next, an operation will be described.

First, a light beam is made incident, and split in two directions by the beam splitter 2. The power of a first beam obtained by the division of the light beam is received by the photo-detector 3, and the power of the second beam similarly obtained is split by the polarizing beam splitter 4 to first and second polarized light components vibrated in directions orthogonal to each other. The first polarized light component transmitted through the polarizing beam splitter 4 to advance in the direction of a z axis is made incident on the birefringence crystal 5 having a polarized state changed according to a wavelength, passed through the polarizer 6 after the transmission, and received by the photo-detector 7. The second polarized light component reflected by the polarizing beam splitter 4 to advance in the direction of an x axis is made incident on the birefringence crystal 8 for changing a polarized state according to a wavelength, passed through the polarizer 9 after the transmission, and received by the photo-detector 10.

Each of electric signals outputted from the photo-detectors 3, 7 and 10 are entered to the wavelength detecting circuit 11.

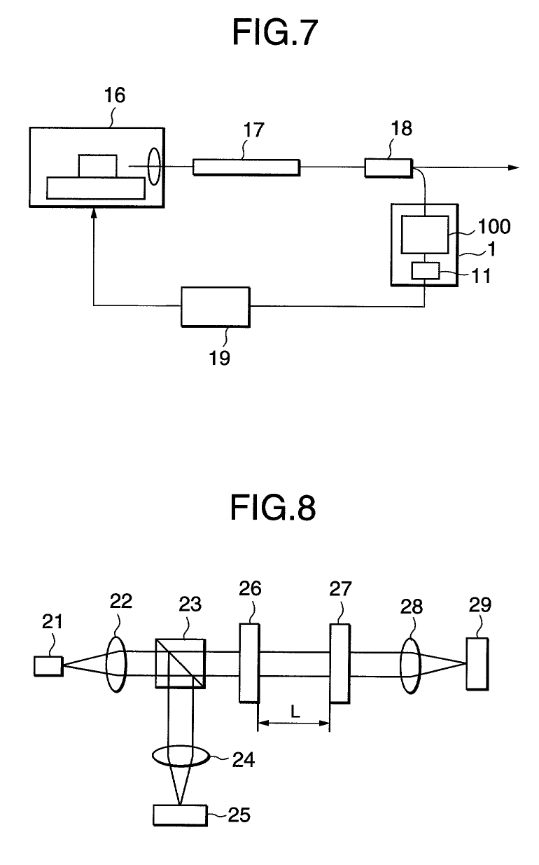

In the wavelength detecting circuit 11, the electric signals outputted from the photo-detectors 7 and 10 are added together by an adder prepared inside. In addition, in the wavelength detecting circuit 11, by using a divider prepared inside, the result of the addition is divided by the electric signal outputted from the photo-detector 3, and the result of the division is outputted to the wavelength control circuit. Though not shown in FIG. 1, the wavelength control circuit will be described in detail later by referring to FIG. 7.

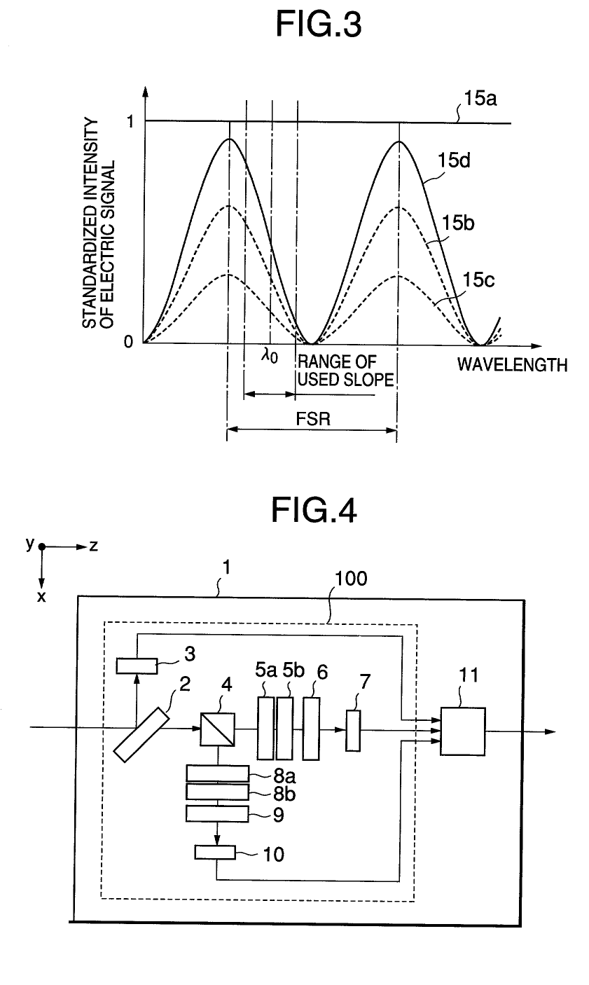

FIG. 3 is a graph showing the intensity of an electric signal outputted from each of the photo-detectors 3, 7 and 10. In the drawing, a reference numeral 15a denotes the intensity of an electric signal outputted from the photo-detector 3; 15b the intensity of an electric signal outputted from the photo-detector 7; 15c the intensity of an electric signal outputted from the photo-detector 10; and 15d the sum of 15b and 15c added by the adder in the wavelength detecting circuit 11.

Since the birefringence crystals 5 and 8 are disposed such that the fast and slow axes F and S are tilted by 45° with respect to the vibration direction of the light beam, an extinction ratio becomes maximum, making it possible to obtain intensity data having minimum DC offset as shown.

In addition, because of the installation of the polarizers 6 and 9 to set the respective polarizing directions of transmitted beams orthogonal to each other, phases are matched with each other between the intensities 15b and 15c of the electric signals respectively outputted from the photo-detectors 7 and 10, enabling the intensity 15d to be obtained as a result of the addition thereof. Thus, it is possible to set the change of the electric signal intensity in a corresponding relation to a wavelength change in a linear approximation range around a wavelength λ0 within a used slope range shown in FIG. 3.

Electric signal 15a outputted from the photo-detector 3 express the optical power of the light beam which is made incident. Therefore, a signal obtained by dividing 15d by 15a turns into a highly accurate wavelength detecting signal not changed even when fluctuation occurs in the intensity of the light beam.

As described above, according to the first embodiment of the invention, the wavelength detector comprises: the polarizing beam splitter 4 for splitting the light beam emitted from the light source to the first and second polarized light components orthogonal to each other; the photo-detectors 7 and 10 for receiving the first and second polarized light components, and outputting corresponding electric signals, respectively; the two wavelength filters respectively disposed in the first and second optical paths between the polarizing beam splitter 4 and the photo-detector 7 and between the polarizing beam splitter 4 and the photo-detector 10, each filter being composed of a birefringence crystal and a polarizer; and the wavelength detecting circuit 11 for receiving the electric signal, and outputting an output signal corresponding to the wavelength of the incident light beam. Therefore, it is possible to provide a highly accurate wavelength detector, which has no movable portions to be adjusted, and is compact and easy for initial alignment.

The wavelength detector further comprises: the beam splitter 2 disposed in the optical path between the light source and the polarizing beam splitter 4 to split a light beam; and the photo-detector 3 for receiving the split light beam, and generating an electric signal corresponding to the power of the split light beam. The wavelength detecting circuit 11 adds the electric signals from the photo-detectors 7 and 10, and divides the sum of the electric signals by the electric signal from the photo-detector 3 to generate an output signal. Therefore, it is possible to obtain a highly accurate detecting signal not changed even when fluctuation occurs in the intensity of the light beam.

Furthermore, since the fast axis of the birefringence crystals 5 and 8 is tilted by 45° with respect to the vibration direction of the incident light beam, it is possible to obtain intensity data having minimum DC offset.

Second Embodiment

FIG. 4 is a block diagram showing a wavelength detector according to the second embodiment of the invention. In FIG. 4, for each of the first and second polarized light components, there are two birefringence crystals: first and second birefringence crystals 5a and 5b for the first polarized light component; and first and second birefringence crystals 8a and 8b for the second polarized light component. Component denoted by other reference numerals are similar to those of the first embodiment, and thus description thereof will be omitted.

The second birefringence crystals 5b and 8b are disposed in such a way as to compensate a change in a phase deviation quantity 8 caused by a refractive index change occurring because of the temperature changes of the first birefringence crystals 5a and 8a.

When a change dΔn_{A}/dT in a refractive index difference Δn_{A} between a refractive index of fast axis and second axis of the first birefringence crystals, and a change Δn_{B}/dT in a refractive index difference Δn_{B} between a refractive index of fast axis and second axis of the second birefringence crystals both take positive or negative values at the time of temperature changing, the birefringence crystals are disposed such that the fast axis of the first birefringence crystals and the slow axis of the second birefringence crystals coincide with each other, and the slow axis of the first birefringence crystals and the fast axis of the second birefringence crystals coincide with each other.

On the other hand, when one of the changes dΔn_{A}/dT and dΔn_{B}/dT takes a positive value, and the other takes a negative value, the birefringence crystals are disposed such that the respective fast axes of the first and second birefringence crystals coincide with each other, and the respective slow axes of the first and second birefringence crystals coincide with each other.

In the case of the disposition where the fast axis of the first birefringence crystals coincide with the slow axis of the second birefringence crystals, and the slow axis of the first birefringence crystals coincide with the fast axis of the second birefringence crystals, a free spectral region (FSR) is represented by an equation (1). In the case of the disposition where the respective fast axes of the first and second birefringence crystals coincide with each other, and the respective slow axes of the first and second birefringence crystals coincide with each other, an FSR is represented by an equation (2).

$$\begin{matrix}FSR = \frac{{c}_{0}}{( Δ {n}_{A} \cdot {L}_{A} + Δ {n}_{B} \cdot {L}_{B} )} = \frac{{λ}^{2}}{( Δ {n}_{A} \cdot {L}_{A} + Δ {n}_{B} \cdot {L}_{B} )} & [ Equation 1 ] \\ FSR = \frac{{c}_{0}}{( Δ {n}_{A} \cdot {L}_{A} - Δ {n}_{B} \cdot {L}_{B} )} = \frac{{λ}^{2}}{( Δ {n}_{A} \cdot {L}_{A} - Δ {n}_{B} \cdot {L}_{B} )} & [ Equation 2 ]\end{matrix}$$

When the sum total of antinodes or nodes of a light beam propagated through the first and second birefringence crystals is m, a wavelength λ of the light beam is represented by an equation (3).

$$λ = \frac{( Δ {n}_{A} \cdot {L}_{A} + Δ {n}_{B} \cdot {L}_{B} )}{m} \qquad [ Equation 3 ]$$

When differentiation is carried out to erase m with a temperature set as a variable, the equation (3) is represented by an equation (4). The equation (4) represents a change in a reference wavelength when a temperature is changed. Here, α_{A} denotes a coefficient of linear expansion in the light beam propagating direction of the first birefringence crystal; and α_{B} a coefficient of linear expansion in the light beam propagation direction of the second birefringence crystal.

$$\frac{\partial λ}{\partial T} = \{ ( \frac{ⅆ Δ {n}_{A}}{ⅆ T} + {α}_{A} \cdot Δ {n}_{A} ) \cdot {L}_{A} + ( \frac{ⅆ Δ {n}_{B}}{ⅆ T} + {α}_{B} \cdot Δ {n}_{B} ) \cdot {L}_{B} \} \cdot \frac{λ}{( Δ {n}_{A} \cdot {L}_{A} + Δ {n}_{B} \cdot {L}_{B} )} \qquad [ Equation 4 ]$$

In this case, by preparing the first and second birefringence crystals such that L_{A} and L_{B} satisfy an equation (5), the right side of the equation (4) becomes 0, making it possible to prevent changes in the reference wavelength caused by a temperature change.

$$( \frac{ⅆ Δ {n}_{A}}{ⅆ T} + {α}_{A} \cdot Δ {n}_{A} ) \cdot {L}_{A} + ( \frac{ⅆ Δ {n}_{B}}{ⅆ T} + {α}_{B} \cdot Δ {n}_{B} ) \cdot {L}_{B} = 0 \qquad [ Equation 5 ]$$

As a preferable example of a combination of the first birefringence crystals 5a and 8a and the second birefringence crystals 5b and 8b, a combination using a YVO₄ crystal as the first birefringence crystal and an LiNBO₃ as the second birefringence crystal can be cited from the standpoint of performance and availability. In the case of such a combination, dΔn_{A}/dT and dΔn_{B}/dT both take negative values. With FSR set at 800 GHz (6.4 nm), values of L_{A} and L_{B} are obtained from the equations (2) and (5) as follows:

LA=0.9725 mm, LB=0.1494 mm

As described above, according to the second embodiment, there are two birefringence crystals for each polarized light component: the first and second birefringence crystals 5a and 5b for the first polarized light component; and the first and second birefringence crystals 8a and 8b for the second polarized light component, and the second birefringence crystals 5b and 8b are disposed to compensate a change in the phase deviation quantity δ caused by a refractive index change occurring by the temperature changes of the first birefringence crystals 5a and 8a. Therefore, no changes occur in the wavelength to be monitored by the temperature change, making it unnecessary to perform compensation by a temperature change, in addition to an advantage similar to that provided by the first embodiment.

If a combination of a YVO₄ crystal for the first birefringence crystal and an LiNBO₃ crystal for the second birefringence crystal is used as a preferable combination of birefringence crystals, it is possible to compensate a change in the phase deviation quantity δ caused by a refractive index change occurring by the temperature change, making it unnecessary to perform compensation by a temperature change.

Third Embodiment

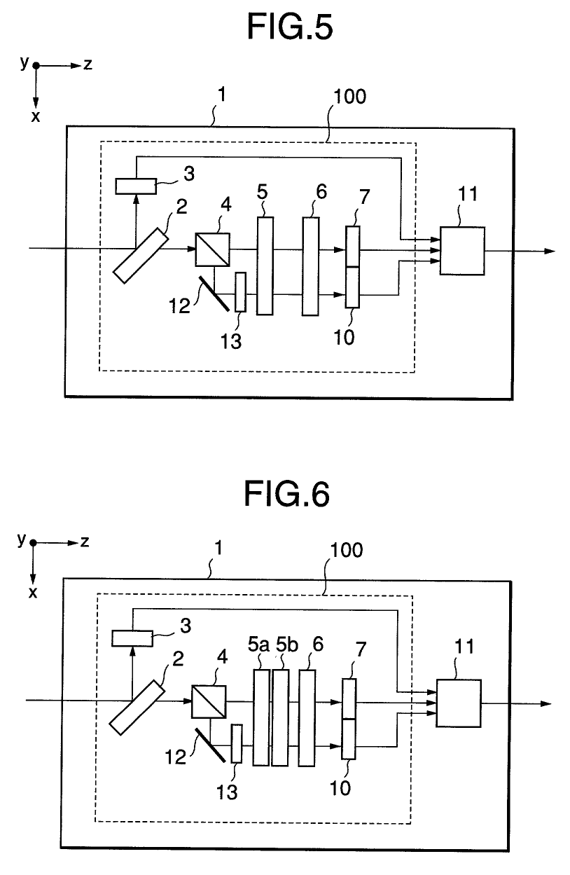

FIG. 5 shows a wavelength detector according to the third embodiment of the invention. In FIG. 5, a wavelength detector main body 1 comprises: an optical system 100 and a wavelength detecting circuit 11. The optical system 100 includes a beam splitter 2, a photo-detector 3, a polarizing beam splitter 4, a mirror 12, a half-wave plate 13, a birefringence crystal 5, a polarizer 6, and photo-detectors 7 and 10.

The beam splitter 2 splits an incident light beam in two directions. The photo-detector 3 receives a power of a first light beam split by the beam splitter. The polarizing beam splitter 4 receives a power of a second light beam split by the beam splitter, and splits it to first and second polarized light components vibrated in directions orthogonal to each other. The mirror 12 changes the advancing direction of the second polarized light component to match the advancing direction of the first polarized light component. The birefringence crystal 5 receives the first polarized light component, and the second polarized light component transmitted through the half-wave plate 13, and changes the polarized states of the first and second polarized light components according to the wavelength of the light beam. The polarizer 6 receives the light beam from the birefringence crystal 5, and transmits only the polarized light of a specified direction. The photo-detector 7 receives the first polarized light component transmitted through the polarizer 6. The photo-detector 10 receives the second polarized light component transmitted through the polarizer 6. The wavelength detecting circuit 11 receives outputs from the photo-detectors 3, 7 and 10.

According to the invention, the birefringence crystal 5 disposed such that the direction of a fast axis F or a slow axis S is tilted by 45° with respect to the vibration direction of the incident light beam.

Next, an operation will be described.

A light beam is made incident, and split by the beam splitter 2 in two directions. The power of a first light beam obtained by the splitting is received by the photo-detector 3, and the power of a second light beam obtained by the splitting is split by the polarizing beam splitter 4 to first and second polarized light components vibrated in directions orthogonal to each other. The first polarized light component transmitted through the polarizing beam splitter 4 to advance in the direction of a z axis is made incident on the birefringence crystal 5 for changing the polarized state according to a wavelength, passed through the polarizer 6 after the transmission, and received by the photo-detector 7. The second polarized light component reflected by the polarizing beam splitter 4 to advance in the direction of an x axis is changed for its advancing direction by the mirror 12, and matched with the advancing direction (direction of the z axis) of the first polarized light component. Then, the second polarized light component is transmitted through the half-wave plate 13 for rotating a polarizing direction by 900, and thereby the polarizing direction is matched with that of the first polarized light component. Thus, the second polarized light component is made incident on the birefringence crystal 5 for changing the polarized state according to the wavelength, passed through the polarizer 6 after the transmission, and received by the photo-detector 10. Electric signals outputted from the photo-detectors 3, 7 and 10 are entered to the wavelength detecting circuit 11.

In the wavelength detecting circuit 11, the electric signals outputted from the photo-detectors 7 and 10 are added by an adder prepared inside. In addition, by a divider prepared inside, the result of the addition is divided by an electric signal outputted from the photo-detector 3, and the result thereof is outputted to a wavelength control circuit.

In this case, since the receiving surfaces of the photo-detectors 7 and 10 can be arrayed on the same plane as shown, alignment adjustment is facilitated by installing the photo-detectors 7 and 10 on the same substrate. Moreover, the receiving surfaces may be enlarged to receive the first and second polarized light components together, and the result of addition may be outputted.

Because of the foregoing configuration, in the third embodiment, the electric signals 15a and 15d shown in FIG. 2 can be obtained, calculated by the divider (15d/15a) by the divider in the wavelength detecting circuit 11, and this is outputted as the output of the wavelength detecting circuit 11 to the wavelength control circuit located outside.

According to the third embodiment of the invention, the wavelength detector comprises: the polarizing beam splitter 4 for splitting the light beam emitted from the light source to the first and second polarized light components orthogonal to each other; the photo-detectors 7 and 10 for receiving the first and second polarized light components, and outputting the corresponding electric signals; the wavelength filters disposed in the first and second optical paths between the polarizing beam splitter 4 and the photo-detector 7 and between the polarizing beam splitter 4 and the photo-detector 10, each filter being composed of the birefringence crystal 5 and the polarizer 6; the half-wave plate 13 disposed between the polarizing beam splitter 4 and the wavelength filter of the second optical path; the mirror 12 disposed between the polarizing beam splitter 4 and the half-wave plate 13 of the second optical path; and the wavelength detecting circuit 11 for receiving the electric signal, and outputting an output signal corresponding to the wavelength of the incident light beam. Therefore, it is possible to provide a highly accurate wavelength detector, which has no movable parts to be adjusted, is compact, easy for initial alignment and high in cost performance.

The wavelength detector further comprises: the beam splitter 2 disposed in the optical path between the light source and the polarizing beam splitter 4 to split the light beam; and the photo-detector 3 for receiving the split light beam, and generating the electric signal corresponding to the power of the split light beam. The wavelength detecting circuit 11 adds the electric signals from the photo-detectors 7 and 10, and the sum of the electric signals is divided by the electric signal from the photo-detector 3 to generate an output signal. Therefore, it is possible to obtain a highly accurate wavelength detecting signal not changed even when fluctuation occurs in the intensity of the light beam.

Furthermore, since the fast axis of the birefringence crystal 5 is tilted by 45° with respect to the vibration direction of the light beam, it is possible to obtain intensity data having minimum DC offset.

Fourth Embodiment

FIG. 6 is a block diagram showing a wavelength detector according to the fourth embodiment of the invention. In FIG. 6, for first and second polarized light components, there are two birefringence crystals, i.e., first and second birefringence crystals 5a and 5b respectively. Components denoted other reference numerals are similar to those of the third embodiment, and thus description thereof will be omitted.

The second birefringence crystal 5b is disposed to compensate a change in a phase deviation quantity δ caused by a refractive index change occurring by a temperature change.

The characteristic of the configuration is similar to that of the second embodiment, and thus description thereof will be omitted.

Fifth Embodiment

FIG. 7 shows an example of a configuration of an optical transmitter using the wavelength detector specified in one of the first to fourth embodiments of the invention.

In FIG. 7, the optical transmitter of the invention comprises: an LD module 16 for emitting a light beam: an optical fiber 17 for transmitting the emitted light beam; a branch coupler 18 for splitting the transmitted light beam to an original communication line and a detection line; a wavelength detector 1 for receiving the light beam split to the detection line; and a wavelength control circuit 19 for receiving a wavelength detecting signal from the wavelength detector.

Next, an operation will be described.

A light beam emitted from the LD module 16 is transmitted through the optical fiber 17. The branch coupler 18 is provided in the midway of this transmission line. The light beam transmitted through this branch coupler 18 is passed to the communication line, and a part of the light beam branched to the detection line side by the branch coupler 18 is made incident on the wavelength detector 1. The wavelength detector 1 outputs a wavelength detecting signal to the wavelength control circuit 19. The wavelength control circuit 19 controls the oscillation wavelength of the LD module 16 by using the wavelength detecting signal.

As described above, the optical transmitter of the invention comprises: the LD module 16 for emitting a light beam; the optical fiber cable 17 for transmitting the emitted light beam; the branch coupler 18 provided in the midway of the optical fiber cable to split the transmitted light beam; the wavelength control circuit 19 for controlling the wavelength of the light beam emitted from the LD module 16; and the wavelength detector 1 disposed in the branch coupler 18 and the wavelength control circuit 19. Thus, it is possible to detect a wavelength by inserting the branch coupler in the optional position of the communication network using the optical fiber. In addition, since the wavelength detector is provided separately from the LD module, even when abnormal oscillation occurs in the LD module or Peltier device or the like fails in the module, it is only necessary to replace the failed portion, making it possible to reduce the loads of maintenance and adjustment.

For the optical transmitter, the components may be optionally combined and packaged. For example, the LD module 16, the optical fiber 17 and the wavelength control circuit 19 may be housed in one package.

With only the wavelength control circuit 19 separately provided, the other components, i.e., the LD module 16, the optical fiber 17, the branch coupler 18, and the wavelength detector 1 may be collected in one package.

Furthermore, the wavelength detector 1 may be separated into the optical system 100 and the wavelength detecting circuit 11, and the optical system 100 may packaged with the LD module 16, the optical fiber 17, and the branch coupler 18. The remaining component, i.e., the wavelength detecting circuit 11 may be incorporated in the wavelength control circuit 19.

As described above, the wavelength detector of the present invention is constructed in such a manner that an incident light beam is split by the beam splitter, the power of one split light beam is detected, the other split light beam is split to two polarized light components orthogonal to each other, and then passed through the so-called wavelength filters, each being composed of the birefringence crystal and the polarizer, the polarized light components are respectively received by the photo-detectors, and the electric signals are sent to the wavelength detecting circuit, and then outputted as a wavelength detecting signal after addition and division in the wavelength detecting circuit. Thus, it is possible to provide a wavelength detector compact and easy for alignment.

The advancing direction of the second polarized light component obtained by splitting at the polarizing beam splitter is changed by the mirror to match the advancing direction of the first polarized light component, and subjected to phase rotation by the half-wave plate to be made incident on the pair of a birefringence crystal and a polarizer. Thus, it is possible to facilitate alignment, and reduce costs.

In addition, for each of the split polarized light components, two birefringence crystals are prepared, and disposed to compensate a change in a phase deviation quantity caused by a refractive index change occurring by the temperature change of the first birefringence crystal. Thus, any changes in the wavelength to be monitored by the temperature change can be prevented, making it possible to provide a wavelength detector needing no compensation by a temperature change.

Furthermore, it is possible to provide a wavelength detector capable of detecting a wavelength in the optional position of the communication network using the optical fiber, even when polarization-preserving fiber is used, or even in the case of a light beam transmitted for a long distance, and abnormally polarized.

What is claimed is:

1. A wavelength detector for detecting a wavelength of a light beam emitted from a light source, comprising:
a polarizing beam splitter configured to split the light beam to first and second beams, said first and second beams having first and second polarized light components, respectively, that have an orthogonal relationship to each other;
first and second photo-detectors configured to receive said first and second light beams and output first and second electric signals, respectively;
first and second wavelength filters disposed in first and second optical paths between said polarizing beam splitter and said first photo-detector and between said polarizing beam splitter and said second photo-detector, respectively.

2. A wavelength detector for detecting a wavelength of a light beam emitted from a light source, comprising:
a polarizing beam splitter configured to split the light beam to first and second beams, said first and second beams having first and second polarized light components, respectively, that have an orthogonal relationship to each other;
first and second photo-detectors configured to receive said first and second light beams and output first and second electric signals, respectively;
first and second wavelength filters disposed in first and second optical paths between said polarizing beam splitter and said first photo-detector and between said polarizing beam splitter and said second photo-detector, respectively;
a detecting circuit for generating, based on said first and second electric signals, an output signal corresponding to the wavelength of said light beam.

3. A wavelength detector as set forth in claim 2, further comprising:
a beam splitter disposed in an optical path from said light source to said polarizing beam splitter to generate another light beam, and
a third photo-detector configured to receive said another light beam and generate a third electric signal corresponding to a power of said another beam,
said detecting circuit generating said output signal by adding said first and second electric signals to each other and then dividing the added first and second electric signals by said third electric signal.

4. A wavelength detector as set forth in claim 1, wherein said first and second wavelength filter is constructed by combination of a birefringence crystal and a polarizer, respectively.

5. A wavelength detector as set forth in claim 4, wherein fast axis of said birefringence crystal is set 45 degree tilted to the polarization of the light beam.

6. A wavelength detector as set forth in claim 1, wherein said first and second wavelength filter is constructed by combination of first birefringence crystal, second birefringence crystal and a polarizer, respectively.

7. A wavelength detector as set forth in claim 6, wherein fast axis of said first birefringence crystal is set 45 degree tilted to the polarization of the light beam.

8. A wavelength detector as set forth in claim 6, wherein said second birefringence crystal is set to compensate phase deviation between fast axis and slow axis of said first birefringence crystal occurring by thermal change.

9. A wavelength detector as set forth in claim 8, wherein YV0₄ crystal is used as said first birefringence crystal and LiNbO₃ crystal is used as said second birefringence crystal.

10. A wavelength detector for detecting a wavelength of a light beam emitted from a light source, comprising:
a polarizing beam splitter configured to split the light beam to first and second beams, said first and second beams having first and second polarized light components, respectively, that have an orthogonal relationship to each other;
first and second photo-detectors configured to receive said first and second light beams and output first and second electric signals, respectively;
a wavelength filter disposed in first and second optical paths between said polarizing beam splitter and said first and second photo-detector;
a half-wave plate disposed in said second optical path between said polarizing beam splitter and said wavelength filter to rotate the polarization of said second light beam.
a mirror disposed in said second optical path between said polarized beam splitter and said half-wave plate to make direction of said second optical path parallel to said first optical path.

11. A wavelength detector for detecting a wavelength of a light beam emitted from a light source, comprising:
a polarizing beam splitter configured to split the light beam to first and second beams, said first and second beams having first and second polarized light components, respectively, that have an orthogonal relationship to each other;
first and second photo-detectors configured to receive said first and second light beams and output first and second electric signals, respectively;
a wavelength filter disposed in first and second optical paths between said polarizing beam splitter and said first and second photo-detector;
a half-wave plate disposed in said second optical path between said polarizing beam splitter and said wavelength filter to rotate the polarization of said second light beam.
a mirror disposed in said second optical path between said polarized beam splitter and said half-wave plate to make direction of said second optical path parallel to said first optical path;
a detecting circuit for generating, based on said first and second electric signals, an output signal corresponding to the wavelength of said light beam.

12. A wavelength detector as set forth in claim 10, wherein first and second photo-detectors disposed on one substrate.

13. A wavelength detector as set forth in claim 11, further comprising:
a beam splitter disposed in an optical path from said light source to said polarizing beam splitter to generate another light beam, and
third photo-detector configured to receive said another light beam and generate a third electric signal corresponding to a power of said another light beam,
said detecting circuit generating said output signal by adding said first and second electric signals to each other and then dividing the added first and second electric signals by said third electric signal.

14. A wavelength detector as set forth in claim 10, wherein said wavelength filter is constructed by combination of a birefringence crystal and a polarizer.

15. A wavelength detector as set forth in claim 14, wherein fast axis of said birefringence crystal is set 45 degree tilted to the polarization of the light beam.

16. A wavelength detector as set forth in claim 10, wherein said wavelength filter is constructed by combination of first birefringence crystal, second birefringence crystal and a polarizer.

17. A wavelength detector as set forth in claim 16, wherein fast axis of said first birefringence crystal is set 45 degree tilted to the polarization of the light beam.

18. A wavelength detector as set forth in claim 16, wherein said second birefringence crystal is set to compensate phase deviation between fast axis and slow axis of said first birefringence crystal occurring by thermal change.

19. A wavelength detector as set forth in claim 18, wherein YVO₄ crystal is used as said first birefringence crystal and LiNbO₃ crystal is used as said second birefringence crystal.

20. An optical transmitter for transmitting light, comprising:
a light source emitting light beam;
an optical fiber cable for transmitting light beam;
a coupler disposed in between said optical fiber cable configured to split the light beam;
a wavelength detector for detecting a wavelength of a light beam;
and control circuit for controlling the light source, said wavelength detector comprising:
a polarizing beam splitter configured to split the light beam to first and second beams, said first and second beams having first and second polarized light components, respectively, that have an orthogonal relationship to each other;
first and second photo-detectors configured to receive said first and second light beams and output first and second electric signals, respectively;
first and second wavelength filters disposed in first and second optical paths between said polarizing beam splitter and said first photo-detector and between said polarizing beam splitter and said second photo-detector, respectively;
a detecting circuit for generating, based on said first and second electric signals, an output signal corresponding to the wavelength of said light beam.
